(19) United States
(12) Patent Application Publication
(10) Pub. No.: US 2020/0282366 A1
(43) Pub. Date: Sep. 10, 2020

(54) HEATING DEVICE FOR MIXER HEADS

(71) Applicant: Zeta Biopharma GmbH, Lieboch (AT)

(72) Inventor: Georg PÖSCHL, Graz (AT)

(73) Assignee: Zeta Biopharma GmbH, Lieboch (AT)

(21) Appl. No.: 16/648,074

(22) PCT Filed: Sep. 14, 2018
(86) PCT No.: PCT/AT2018/060213

§ 371 Date: Mar. 17, 2020

(30) Foreign Application Priority Data
Sep. 18, 2017 (AT) A 50785/2017

(51) Int. Cl. B01F 7/00; B01F 7/22

(52) U.S. Cl. CPC B01F 7/001; B01F 15/065; B01F 7/22

(57) ABSTRACT

A device made of a temperature control device (1) and a stirring head (2), wherein the temperature control device (1) comprises an adapter (3), and the adapter (3) comprises an outer adapter surface (7), an adapter interior (8) with an inner adapter surface (9), and a temperature control element (10) for heating the adapter (3) to an operating temperature, and wherein the adapter (3) is open on a face side toward the adapter interior (8), and the stirring head (2) has a bearing hub (4) with an outer bearing hub surface (5), an inner bearing hub surface (6) and a bearing bush, and the bearing bush is positively fitted into the bearing hub (4), while abutting the inner bearing hub surface (6), and wherein the adapter interior (8) is designed for accommodating the bearing hub (4), with the outer bearing hub surface (5) abutting the inner adapter surface (9) essentially completely.

The invention relates to a device made of a temperature control device and a stirring head.

In the sectors of biopharmaceutical industry, food industry and particularly in the field of aseptic liquid production processes, stirring heads are used as part of agitators in stirring containers. Stirring containers are usually designed as gas-tight and closeable, boiler-shaped containers made of metal or glass, which ensure easy cleaning and sterilization and thus multiple use. The mixing of a stirring medium accommodated in the stirring container is effected within the stirring container by means of the stirring head of the agitator, which, depending on the application, may comprise one or several stirring blades. Furthermore, the stirring head can be connected to a stirring shaft with stirring shaft blades arranged thereon in order to homogeneously mix stirring media in containers having a larger volume. In the indicated fields of application, high standards are set with regard to the sterility of the products, whereby production, storage and transportation of those products must occur under sterile conditions. In agitators, the stirring head is conventionally connected to a drive unit by means of a rotating mechanical seal. However, agitators sealed by means of a rotating mechanical seal exhibit the disadvantage that leaks may occur on the seal. Furthermore, the maintenance of this type of seal is labour-intensive and expensive, with the leakage being in the minimum range if maintenance is performed properly. In the pharmaceutical field and in the food industry, however, this leakage and the associated contamination of the stirring medium pose a high risk for the sterility and freedom from contamination of the products. Therefore, those industries increasingly move from agitators sealed with a slide ring toward agitators with a magnetic coupling, which are also referred to as magnetic agitators. The mounting of the stirring head of such agitators occurs via a rotary bearing, such as, for example, a sliding bearing. In this case, the rotary bearing has a bearing hub in which a bearing bush is accommodated. Stirring heads comprising other coupling mechanisms, which, for example, are mechanical, for connection to the drive unit also generally comprise separate rotary bearings. The bearing bush is a wear part, which is exposed to mechanical loads during the operation of the stirring head. On the one hand, the bearing bush wears out continuously as a result of friction in the rotary bearing, on the other hand, vibrations or impacts on the stirring head, which are brought about, for example, by inhomogeneities in the stirring medium, may cause damage to the bearing bush. As a result, the bearing bushes of stirring heads must be checked regularly and replaced, if necessary.

Conventionally, for replacing the bearing bush, the bearing hub of the stirring head is heated manually by a service technician using a hot air blower. In doing so, temperatures of the bearing hub of, for example, 200° C. to 250° C. are achieved. The result of this heating is that the bearing hub expands more strongly than the bearing bush, whereby the bearing bush falls out of the bearing hub or can simply be removed by the service technician.

It has proved to be a drawback of this heating method that, due to the manual heating with the hot air blower, the heating process of the bearing hub proceeds neither in a homogeneous nor in a precisely reproducible fashion. The result is that short-term temperature peaks can occur in the bearing hub, which may lead to high thermal loads on the bearing hub and, subsequently, to material fatigue or stress cracks. Furthermore, because of the high temperatures, the service technicians performing this work are required to wear protective gloves to avoid burn injuries. Nevertheless, such individuals are at an increased risk of suffering burns during this activity.

A further disadvantage of the prior art is that stirring heads which contain temperature-sensitive components cannot be heated by the above-described method due to the risk of exceeding a certain limiting temperature in restricted areas.

It is the object of the present invention to provide a device made of a temperature control device and a stirring head, which circumvents the above-indicated disadvantages.

According to the invention, the present object is achieved in that the temperature control device comprises an adapter, and the adapter comprises an outer adapter surface, an adapter interior with an inner adapter surface, and a temperature control element for heating the adapter to an operating temperature, and wherein the adapter is open on a face side toward the adapter interior, and the stirring head has a bearing hub with an outer bearing hub surface, an inner bearing hub surface and a bearing bush, and the bearing bush is positively fitted into the bearing hub, while abutting the inner surface, and wherein the adapter interior is designed for accommodating the bearing hub, with the outer bearing hub surface abutting the inner adapter surface essentially completely.

The embodiment according to the invention of the device provides a temperature control device and a stirring head, with the temperature control device comprising an adapter for accommodating a bearing hub of the stirring head on an outer bearing hub surface of the bearing hub. The adapter comprises a temperature control element, which heats the adapter to a predetermined operating temperature. If the bearing hub of the stirring head is accommodated in the adapter, the latter encloses the bearing hub on its outer bearing hub surface, thereby ensuring that the bearing hub is heated as uniformly as possible. In this way, the advantage is obtained that the heating process of the bearing hub takes place as homogeneously and reproducibly as possible. In this connection, it is particularly advantageous that temperature peaks in the bearing hub are prevented, as a result of which the thermal load caused by an uneven thermal expansion of the material of the bearing hub is avoided. In further consequence, the risk of stress cracks is reduced and the service life of the stirring head is extended because of reduced material stress during this procedure.

According to a preferred embodiment variant, the stirring head may comprise an additional identification device. Said device can be present, for example, in the form of an RFID chip. The identification device is accommodated at a protected position on the stirring head, in a through-hole between the outer bearing hub surface and an inner bearing hub surface, wherein this through-hole is closed by a stirring blade on the outer bearing hub surface. This hidden identification device serves for uniquely identifying the stirring head even without an optical marking on the stirring head itself. Optical markings on stirring heads are undesirable as they damage the surface structure of the stirring head and involve the risk of bacteria and germs settling locally on the stirring head. However, identification devices as described above generally exhibit enhanced temperature sensitivity, as a result of which manual heating of the stirring head is very likely to result in damage to the identification device. The device according to the invention provides the advantage that temperature peaks are avoided due to the uniform heating of the bearing hub of the stirring head. In this way, the risk of damaging the identification device during the heating process is prevented.

Advantageous embodiments of the device according to the invention, as well as alternative embodiment variants, are explained in further detail below with reference to the figures.

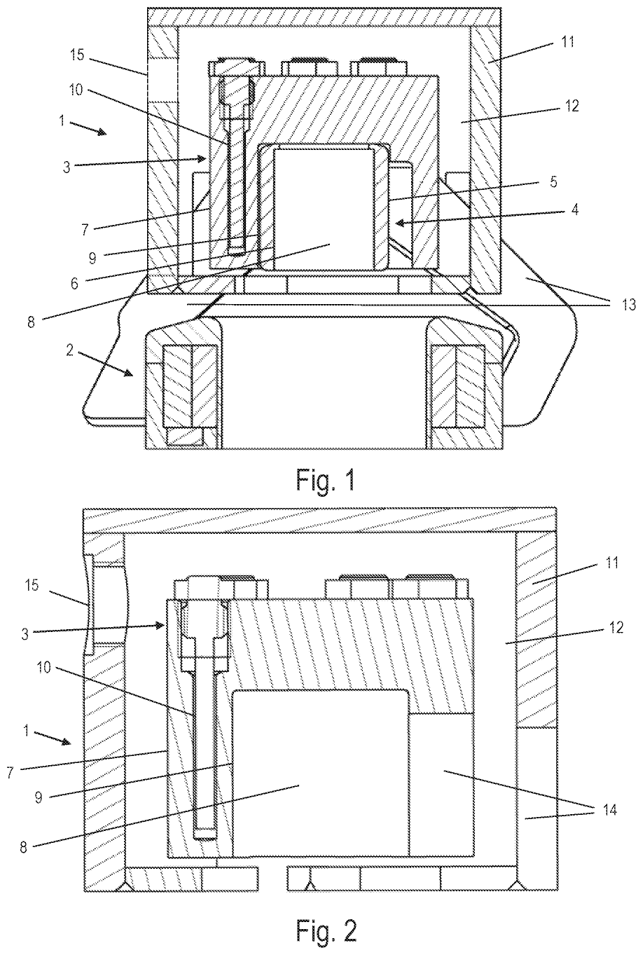

FIG. 1 shows, in a side view, a section through a device according to the invention with a temperature control device and a stirring head accommodated therein.

FIG. 2 shows, in a side view, a section through the temperature control device of FIG. 1.

FIG. 1 shows a sectional view of a device made of a temperature control device 1 and a stirring head 2 in a side view in a preferred embodiment variant. The temperature control device 1 comprises an adapter 3, and the stirring head 2 comprises a bearing hub 4, which is accommodated in the adapter 3. The bearing hub 4 comprises an outer bearing hub surface 5 and an inner bearing hub surface 6 as well as a bearing bush (not shown in FIG. 1), which is positively fitted into the bearing hub 4, while abutting the inner bearing hub surface 6. To provide a better illustration, the temperature control device 1 is depicted in detail in FIG. 2 in a sectional view without the stirring head 2 accommodated therein. The adapter 3 of the temperature control device 1 has an outer adapter surface 7 and is open on a face side toward an adapter interior 8. The adapter interior 8, in turn, has an inner adapter surface 9. The bearing hub 4, as illustrated in FIG. 1, can be accommodated therein, with the outer bearing hub surface 5 abutting the inner adapter surface 9 essentially completely. Furthermore, the adapter 3 has a temperature control element 10, which heats the adapter 3 to an operating temperature. Due to the fact that the bearing hub 4 of the stirring head 2 is accommodated in the adapter 3 and that there is a large contact area between the inner adapter surface 9 and the outer bearing hub surface 5, the advantage is obtained that a particularly good heat transmission between the adapter 3 and the bearing hub 4 is ensured. Furthermore, the bearing hub 4 is heated evenly and reproducibly with each heating process. It is particularly advantageous that this eliminates the need to move the stirring head 2 with the bearing hub 4 during the heating process with a hot air blower in order to ensure heating that is relatively uniform. This reduces the risk of burns for service personnel performing this activity. Another advantage is that the thermal load on the stirring head 2 during this process and the risk of stress cracks and breaks in the stirring head 2 are reduced. Due to the bearing hub 4 being heated to the operating temperature, the bearing hub 4 expands. The bearing bush has a smaller diameter than the bearing hub 4 and is usually made of a material with a lower coefficient of thermal expansion, as a result of which the bearing bush at the position of the device as shown in FIG. 1 falls out of the bearing hub 4 by itself or, respectively, can simply be removed therefrom. In order to insert a new bearing bush into the bearing hub 4, the device made of the stirring head 2 and the temperature control device 1 is simply rotated through 180°, and a new bearing bush is inserted into the bearing hub 4. If the temperature of the bearing hub 4 is brought back down to an initial temperature prior to the heating process by switching off the temperature control device 1 or removing the stirring head 2 from the adapter 3, the bearing hub 4 will re-contract and the bearing bush will be fixed in the bearing hub 4.

The temperature control device 1 illustrated in FIG. 1 and in FIG. 2 furthermore has a housing 11 and an insulation 12. The outer adapter surface 7 is essentially completely surrounded by the insulation 12, and the insulation 12 is essentially completely surrounded by the housing 11. The insulation 12 and the housing 11 are thus arranged essentially completely around the adapter 3, except for the face side. In this preferred embodiment variant, the adapter 3 is thermally insulated on the outer adapter surface 7. In this way, the advantage is obtained that the temperature control device 1 can be touched and manipulated even with the temperature control element 10 switched on. It is particularly advantageous that the risk of burns for service personnel working with the device according to the invention is thereby further reduced. In addition, the temperature control device 1 can thus be moved in any operating state and, for example, can be turned over without protective gloves for inserting a new bearing bush.

The stirring head 2 illustrated in FIG. 1 additionally comprises stirring blades 13 which are arranged on the outer bearing hub face 5. In a preferred embodiment variant, the stirring head 2 has at least one stirring blade 13. The adapter 3 has a slot 14 (see FIG. 2), which starts at the face side and extends from the adapter interior 8 to the outer adapter surface 7, for accommodating the at least one stirring blade 13. When the bearing hub 4 is accommodated in the adapter interior 8, the stirring blade 13 runs through the slot 14 out of the adapter interior 8. The arrangement of stirring blades 13 on the stirring head 2 provides the advantage that the stirring head 2 can be adapted to different stirring media by appropriately choosing the shape of the stirring blades 13. The described design of the adapter 3 with slots 14 achieves the advantage that stirring heads 2 with stirring blades 13 can also be heated by the device according to the invention.

If the temperature control device 1 comprises, as described above, an additional insulation 12 and a housing 11, then, in the embodiment variant of the device having a stirring head 2 with at least one stirring blade 13, the insulation 12 and the housing 11 have at least one slot 14 starting at the outer adapter surface 7 and extending through the insulation 12 and the housing 11, essentially following the course of the slot 14 of the adapter 3. In this way, the advantage is obtained that stirring heads 2 with stirring blades 13 can also be heated by the temperature control device 1 comprising a housing 11 and an insulation 12.

In a preferred embodiment variant, the bearing hub 4 of the stirring head 1 has an identification device (not shown in FIG. 1 and FIG. 2) and a through-hole between the outer bearing hub surface 5 and the inner bearing hub surface 6. The identification device is positioned in the through-hole, with the stirring blade 13 closing the through-hole on the outer bearing hub surface 5. In this way, the advantage is obtained that the stirring head 2 can be clearly identified without an optical marking on its surface. In this case, the identification device can be implemented, for example, by an RFID chip, with this type of identification device showing enhanced temperature sensitivity. The device according to the invention provides the advantage that the stirring head 2 with the identification device is heated uniformly, and thus temperature peaks, which might damage the identification device, are avoided.

According to a further preferred embodiment variant, the temperature control element 10 comprises at least one heating element and at least one thermometer. In this way, the advantage is obtained that a particularly sensitive temperature control of the temperature control device 1 and subsequently of the adapter 3 and the bearing hub 4 is provided. If more than one heating element and more than one thermometer are applied, a particularly uniform heating and a particularly homogeneous temperature distribution of the adapter 3 can be achieved.

As shown in FIG. 1 and FIG. 2, the housing 11 has a cable feed-through opening 15 in a preferred embodiment variant. In this way, the advantage is obtained that the electrical supply lines of the temperature control element 10 are guided out of the housing 11 at a defined point.

The adapter of the temperature control device 1 is preferably made of aluminium, copper or an alloy comprising aluminium and/or copper. In this way, the advantage is obtained that a particularly good heat transfer from the temperature control element 10 to the bearing hub 4 is ensured.

1. A device made of a temperature control device and a stirring head, wherein the temperature control device comprises an adapter, and the adapter comprises an outer adapter surface, an adapter interior with an inner adapter surface, and a temperature control element for heating the adapter to an operating temperature, and wherein the adapter is open on a face side toward the adapter interior,
and the stirring head has a bearing hub with an outer bearing hub surface, an inner bearing hub surface and a bearing bush, and the bearing bush is positively fitted into the bearing hub, while abutting the inner bearing hub surface, and wherein the adapter interior is designed for accommodating the bearing hub, with the outer bearing hub surface abutting the inner adapter surface essentially completely
wherein the stirring head has at least one stirring blade arranged on the outer bearing hub surface, and the adapter has at least one slot starting at the face side and extending from the adapter interior to the outer adapter surface, wherein the stirring blade runs through the slot out of the adapter interior (8) if the bearing hub is accommodated in the adapter interior and
the bearing hub has an identification device and a through-hole between the outer bearing hub surface and the inner bearing hub surface, with the identification device being positioned in the through-hole and the stirring blade closing the through-hole on the outer bearing hub surface.

2. A device according to claim 1, wherein the temperature control device comprises a housing and an insulation (12), wherein the outer adapter surface is essentially completely surrounded by the insulation, and wherein the insulation is essentially completely surrounded by the housing.

3. A device according to claim 1, wherein the temperature control device comprises a housing and an insulation, wherein the outer adapter surface is essentially completely surrounded by the insulation, wherein the insulation is essentially completely surrounded by the housing, and wherein the insulation and the housing have at least one slot starting at the outer adapter surface and extending through the insulation and the housing, essentially following the course of the slot of the adapter.

4. A device according to claim 1, wherein the temperature control element comprises at least one heating element and at least one thermometer.

5. A device according to claim 2, wherein the housing of the temperature control device has at least one cable feed-through opening.

6. A device according to claim 1, wherein the adapter of the temperature control device is made of aluminium, copper or an alloy comprising aluminium and/or copper.
